(19) United States
(12) Patent Application Publication
(10) Pub. No.: US 2023/0234506 A1
(43) Pub. Date: Jul. 27, 2023

(54) VEHICLE ALERT DEVICE, VEHICLE ALERT METHOD, AND COMPUTER-READABLE RECORDING MEDIUM

(71) Applicant: Honda Motor Co., Ltd., Tokyo (JP)

(72) Inventor: Ayaka NAGATA, Tokyo (JP)

(73) Assignee: Honda Motor Co., Ltd., Tokyo (JP)

(21) Appl. No.: 17/992,825

(22) Filed: Nov. 22, 2022

(30) Foreign Application Priority Data
Jan. 27, 2022 (CN) 202210102060.9

(51) Int. Cl. B60R 1/12; B60R 1/08

(52) U.S. Cl. CPC B60R 1/12; B60R 1/08; B60R 2001/1215; B60R 2001/1253

(57) ABSTRACT

The disclosure provides a vehicle alert device, a vehicle alert method and a computer-readable recording medium. The vehicle alert device includes: a detection portion for detecting an alert target vehicle among road participants around the present vehicle to obtain a detection result; an information display portion, which is disposed on a pair of rearview mirrors of the present vehicle; a control portion, which controls the information display portion to display a predetermined pattern on the information display portion when it is determined based on the detection result that the driver can see the alert target vehicle, so that the predetermined pattern is superimposed on the alert target vehicle displayed on the pair of rearview mirrors.

### CROSS-REFERENCE TO RELATED APPLICATION

This application claims the priority benefit of China application no. 202210102060.9, filed on Jan. 27, 2022. The entirety of the above-mentioned patent application is hereby incorporated by reference herein and made a part of this specification.

### BACKGROUND

### Technical Field

The present disclosure relates to a vehicle alert device, a vehicle alert method and a computer-readable recording medium.

### Description of Related Art

With the development of vehicle technology, driving safety has received increased attention. Vehicle is also equipped with an active and passive driving assistance system, which makes it safer for the driver to drive the vehicle. When a vehicle is driven on the road, there is an area where the driver cannot see the rear vehicle from the rearview mirror (e.g., the side view mirror), and the area is the so-called blind spot area.

The current driving assistance system includes a blind spot information (BSI) system or a rear collision prevention support system, which are able to monitor the blind spot area behind the vehicle at any time. When a vehicle appears, the driver will be alerted through an indicator of the rearview mirror and a warning sound. The BSI system is able to provide assistance to drivers when changing lanes or making a turn, thus reducing accidents and improving driving safety. When a vehicle is driven on the road and there are other vehicles behind the vehicle, the system will automatically light up the indicator on the exterior rearview mirror in the same direction as a notification. If the driver turns on the turn signal light in the same direction, the indicator on the exterior rearview mirror will flash with a warning sound to remind the driver to pay attention to the road condition again.

However, even if there is a blind spot monitoring system, when the rear vehicle is displayed on the rearview mirror of the vehicle, even if the driver can see the rear vehicle from the rearview mirror, sometimes there are conditions that the driver does not notice. In addition, the driver might not be able to determine whether the vehicle in the rearview mirror will enter the blind spot area of the driver, resulting in improper lane change and the danger of collision.

### SUMMARY

Based on the above description, according to an embodiment of the present disclosure, a vehicle alert device is provided, which includes: a detection portion for detecting an alert target vehicle among road participants around the present vehicle to obtain a detection result; an information display portion, which is disposed on a pair of rearview mirrors of the present vehicle; a control portion, which controls the information display portion to display a predetermined pattern on the information display portion when it is determined based on the detection result that the driver can see the alert target vehicle, so that the predetermined pattern is superimposed on the alert target vehicle displayed on the pair of rearview mirrors.

According to an embodiment of the present disclosure, there is provided a vehicle alert method executed by a control portion of a present vehicle. The present vehicle has a pair of rearview mirrors on which an information display portion is provided. The vehicle alert method includes: detecting an alert target vehicle among the road participants around the present vehicle to obtain a detection result; controlling the information display portion to display a predetermined pattern on the information display portion when it is determined based on the detection result that the driver can see the alert target vehicle, so that the predetermined pattern is superimposed on the alert target vehicle displayed on the pair of rearview mirrors.

Therefore, through the vehicle alert device and method of this embodiment, by using different highlight display modes of the rearview mirror, a more obvious display may be used especially for the rear vehicle that is about to enter the blind spot area, so that the driver is able to be more aware of various driving states of the rear vehicles, and then make correct judgments of driving to improve safety when driving vehicles.

### BRIEF DESCRIPTION OF THE DRAWINGS

FIG. 1 is a block diagram of a vehicle alert device.

FIG. 2 is a schematic diagram of a blind spot area in the rear direction of the vehicle.

FIG. 3 is a schematic diagram of a structure of a blind spot monitoring (BSI) and notification portion of FIG. 1.

FIG. 4 is a schematic diagram of a blind spot area of a vehicle.

FIG. 5 is a schematic diagram showing the highlighted display of a rearview mirror according to the embodiment of the present disclosure.

FIG. 6 is a schematic flowchart of a vehicle alert method according to an embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numerals are used in the drawings and description to refer to the same or like parts.

According to an embodiment of the present disclosure, in the above-mentioned vehicle alert device, when the control portion determines based on the detection result that the alert target vehicle is about to enter the blind spot area of the driver of the present vehicle, the control portion performs a more obvious display than the predetermined pattern on the information display portion.

According to an embodiment of the present disclosure, in the above-mentioned vehicle alert device, the more obvious display than the predetermined pattern includes changing the shape or color of the predetermined pattern, or displaying the predetermined pattern in a flashing manner.

According to an embodiment of the present disclosure, in the above vehicle alert device, the predetermined pattern may be a frame.

According to an embodiment of the present disclosure, in the above vehicle alert device, the information display portion may be a transmissive display film.

According to an embodiment of the present disclosure, in the above vehicle alert device, the detection portion acquires the information of the alert target vehicle through at least one of a radar and a camera provided in the present vehicle.

According to an embodiment of the present disclosure, in the vehicle alert method described above, when the control portion determines, based on the detection result, that the alert target vehicle is about to enter the blind spot area of the driver of the present vehicle, the control portion changes the shape or color of the predetermined pattern, or display the predetermined pattern in a flashing manner.

According to an embodiment of the present disclosure, in the above vehicle alert method, the predetermined pattern may be a frame.

According to an embodiment of the present disclosure, there is provided a computer-readable recording medium, which stores a program, and the calculator executes the program to execute the above-mentioned vehicle alert method.

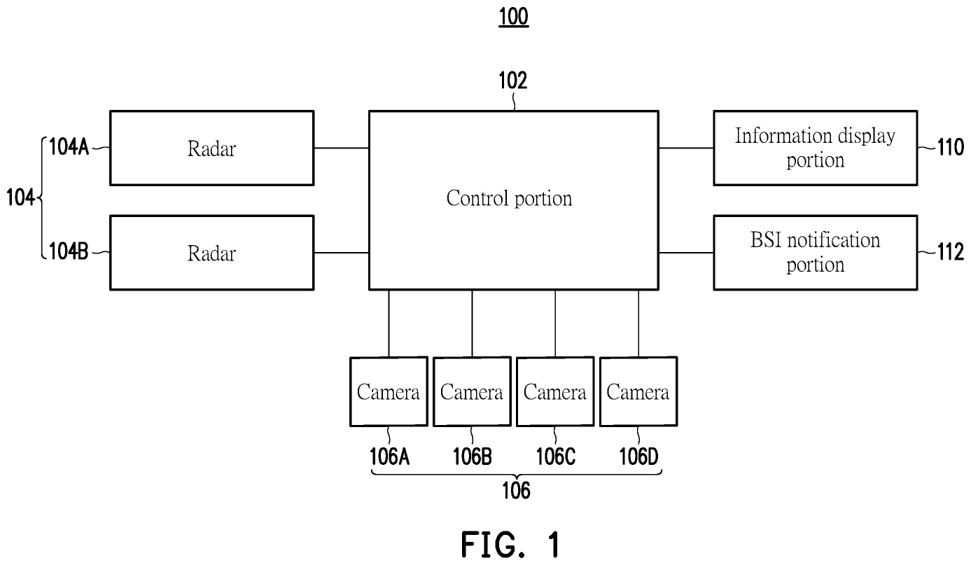

The vehicle alert device of the present disclosure belongs to a part of the vehicle driver support system, and is used to notify the driver of the present vehicle whether there is a rear vehicle that will enter the blind spot area of the present vehicle. FIG. 1 is a block diagram of a vehicle alert device as part of a vehicle driver support system. Generally, a vehicle driver support system is a very complex system, including various active and passive subsystems. However, here, the block diagram of FIG. 1 only illustrates the parts related to the present disclosure, and the other parts are omitted.

As shown in FIG. 1, a vehicle alert device 100 includes a control portion 102 for controlling a plurality of constituent units of the vehicle alert device 100, which is able to receive detection signals sent from various detection portions (e.g., sensors, radars, lidars, cameras, etc.) provided in the vehicle, and then output control signals to control various constituent units. The control portion 102 generally constitutes, for example, an ECU unit of a vehicle.

In FIG. 1, the vehicle alert device 100 further includes a radar 104 and a camera 106. The radar 104 and the camera 106 may be used as the detection portion of the vehicle alert device 100. The number of radars 104 may be more than one, for example, a front radar 104A and a rear radar 104B may be provided on the front and rear bumpers of the vehicle. The radar 104 may utilize radar echo to make the control portion 102 to calculate a distance between the present vehicle and surrounding vehicles.

The number of cameras 106 may also be more than one, for example, cameras may be arranged at the front and rear of the vehicle (e.g., bumper position), the lateral side of the vehicle roof, inside the vehicle (e.g., rearview mirror inside the vehicle), on the rear mirror, and the like. For example, the cameras 106A and 106B may be respectively disposed on a pair of rearview mirrors of the vehicle, so as to capture images of the conditions of the left rear side and the right rear side of the vehicle. The camera 106C may be set at a suitable position behind the vehicle, such as on the rear bumper, etc., to capture images of the conditions behind the vehicle.

The camera 106D may be, for example, disposed on or near the rearview mirror inside the vehicle, and captures images of the situation behind the vehicle at an angle equivalent to the driver's viewing angle. Also, the camera 106D allows the control portion 102 of the vehicle alert device 100 to determine whether the driver can see the rear vehicle from the rearview mirror (inside the vehicle), and the cameras 106A and 106B allow the control portion 102 of the vehicle alert device 100 to determine whether the driver can see the vehicle in the left rear or right rear direction from the rearview mirror (outside the vehicle).

The vehicle in the rear direction here is an example of a road participant. The road participant normally refers to surrounding vehicles in the rear and front directions of the present vehicle, moving objects, etc. that use the road together with the present vehicle, and road participant may generally include vehicles, etc., and even in some cases may include pedestrian.

Based on the information obtained by the radar 104 and the camera 106 (for example, the distance, position, etc. of the present vehicle to the surrounding vehicles), the control portion 102 may calculate the relative position, relative speed, etc. between the present vehicle and the surrounding vehicles, so as to determine whether the surrounding vehicles will enter the predetermined area of the present vehicle, and then some corresponding operations will be performed by the multiple constituent units of the vehicle alert device 100.

The information display portion 110 is controlled by the control portion 102. According to an embodiment of the present disclosure, the information display portion 110 is a pair of rearview mirrors disposed on the vehicle to display the vehicles surrounding the present vehicle. Compared with a conventional rearview mirror composed of a simple mirror surface, the present disclosure is able to display the rear vehicle behind the present vehicle as an alert target vehicle with different highlight modes through the information display portion 110. Based on the information acquired by the above-mentioned radar 104 and camera 106, for example, when the control portion 102 determines that an alert target vehicle enters the field of view of the rearview mirror (outside the vehicle, inside the vehicle), the control portion 102 will display the alert target vehicle in a highlight mode (first highlighted display) on the information display portion 110 of one of the pair of rearview mirrors. In addition, based on the information acquired by the above-mentioned radar 104 and camera 106, when the control portion 102 determines that the alert target vehicle is about to enter the blind spot area of the rearview mirror of the present vehicle, the control portion 102 further controls the information display portion 110 to perform another highlighted display (second highlighted display) to inform the driver that a vehicle will enter the driver's blind spot area.

In other words, the radar 104 and the camera 106 serving as the detection portion detect the alert target vehicle among the road participants around the present vehicle to obtain the detection result. The control portion 102 controls the information display portion 110 to display a predetermined pattern on the information display portion 110 when it is determined based on the detection result that the driver can see the alert target vehicle, so that the predetermined pattern is superimposed on the alert target vehicle displayed on the pair of rearview mirrors. In addition, when the control portion 102 determines based on the detection result that the alert target vehicle is about to enter the blind spot area of the driver of the present vehicle, the control portion 102 performs a more obvious display than the predetermined pattern on the information display portion 110.

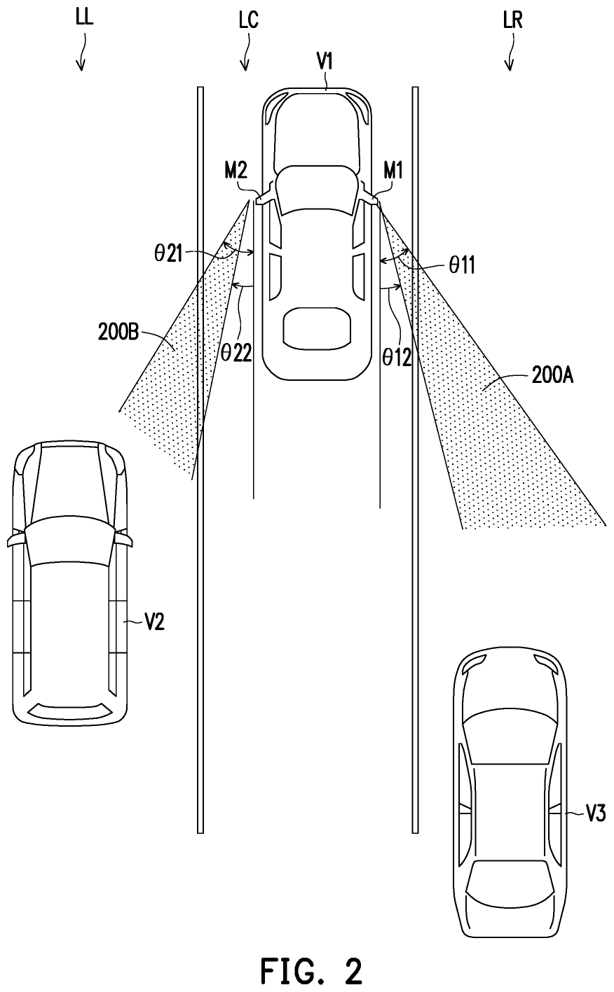

FIG. 2 is a schematic diagram of a blind spot area in the rear direction of the vehicle. As shown in FIG. 2, a traffic situation in which the present vehicle V1 is traveling in the center lane LC, and there are rear vehicles V2 and V3 in the left lane LL and the right lane LR respectively is described below as an example. Meanwhile, in this example, the above-mentioned cameras 160A and 160B are provided on the pair of rearview mirrors M1 and M2 of the present vehicle V1 as an example for illustration. For example, the capturing ranges of the left and right cameras 160A and 160B are θ11 and θ21, the ranges that the driver can see through the rearview mirrors M1 and M2 on the left and right sides are θ12 and θ22, and the areas 200A and 200B are the blind spot areas, in which the driver cannot see the rear vehicle from the rearview mirrors M1 and M2 on the left and right sides. Here, the capturing ranges θ21 and θ11 of the camera may be the same or different, and the viewable ranges θ12 and θ22 may be the same or different.

In this way, the vehicle alert device 100 is able to use the image data, distance data, and the like obtained by the detection device (such as the radar 104 and the camera 106) to enable the control portion 102 to determine whether or not the rear vehicle V2 or V3 will enter the blind spot area 200A or 200B of the present vehicle V1. When the rear vehicle V2 or V3 is about to enter the blind spot area 200A or 200B of the present vehicle, the control portion 102 outputs a control signal to the information display portion 110 to highlight the display.

In addition, the method or means of determining whether the rear vehicles V2 and V3 will enter the blind spot areas 200A and 200B of the present vehicle V1 is only an example. In the vehicle alert device 100, various available detection devices may be used for making judgment, and the present disclosure does not particularly limit the detection methods and means for determining vehicle that enters the blind spot area.

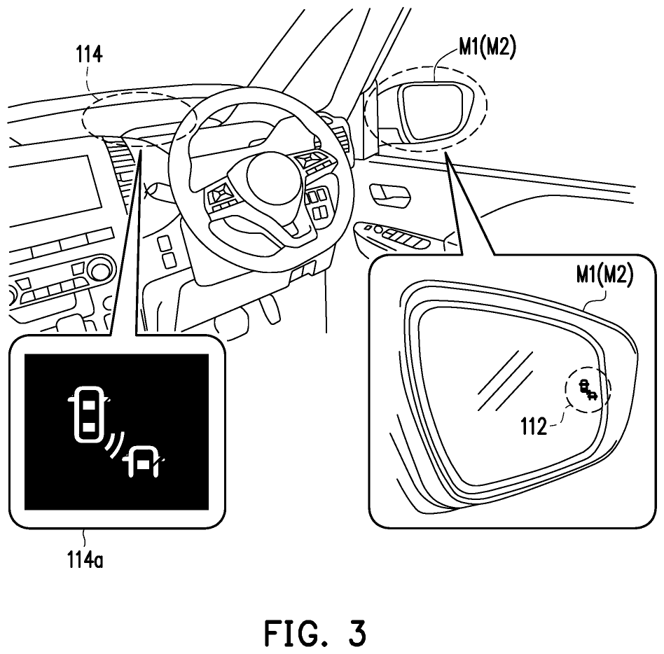

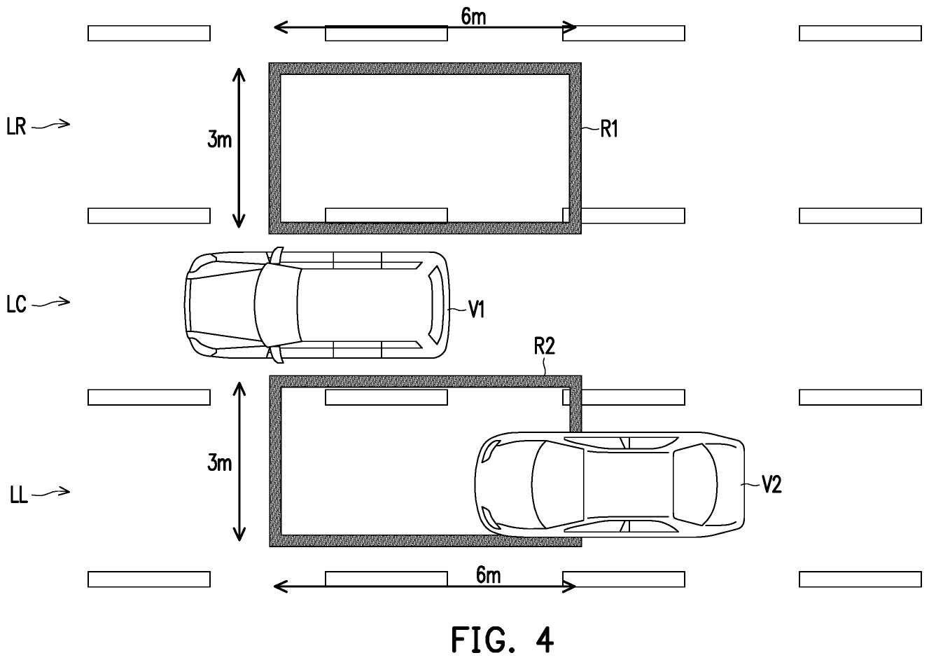

Next, the function of the blind spot monitoring (BSI) and notification portion 112 will be briefly described. FIG. 3 shows a schematic structural diagram of a vehicle blind spot information (BSI) system serving as a BSI notification portion 112. FIG. 4 shows a schematic diagram of a blind spot area of a vehicle. As shown in FIG. 3, on a pair of rearview mirrors M1 and M2 of the present vehicle V1 (one of them is shown as an example), for example, a BSI notification portion 112 is provided at the corners as a blind spot area indicator, which is configured to turn on a light to notify the driver when there are other vehicles entering the blind spot area of the present vehicle. In addition, on the center console 114 inside the present vehicle V1, a corresponding BSI notification portion 114a may also be provided, so that the driver can not only obtain from the rearview mirrors M1 and M2 whether there is a rear vehicle entering the blind spots R1 and R2 shown in FIG. 4, but also can obtain information from the center console 114. As an example, a predetermined area R1 and R2 on the left and right sides of the present vehicle V1 may be set as blind spots. When an oncoming vehicle behind the present vehicle V1 enters the blind spots R1 and R2, the BSI notification portions 112 and 114a shown in FIG. 3 may be activated.

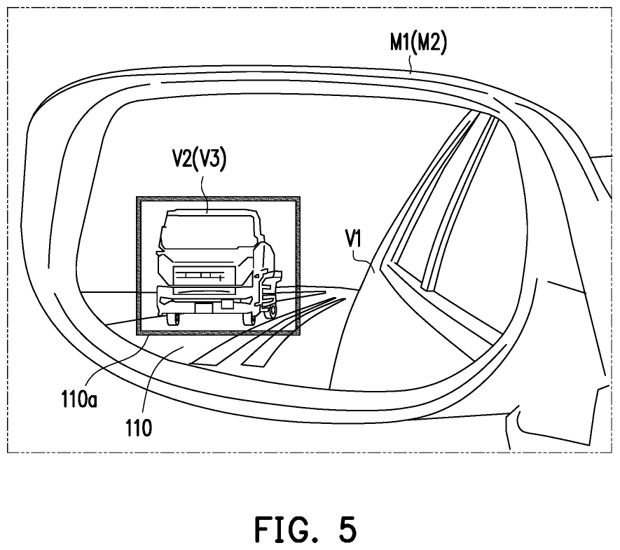

FIG. 5 is a schematic diagram showing the highlighted display of a rearview mirror according to the embodiment of the present disclosure. As shown in FIG. 5, an information display portion 110 is provided on the mirror surface of the rearview mirror M1 (M2), and the information display portion 110 is, for example, a transmissive display film. The information display portion 110 may superimpose a display image on the vehicle V2 (V3), which is reflected on the rearview mirror M1, behind the present vehicle V1. Here, the rear vehicle may be regarded as a road participant, and the road participant generally refers to surrounding vehicles in the rear and front directions of the present vehicle, moving objects, etc. that use the road together with the present vehicle V1.

Next, the highlight display mode on the rearview mirror according to the embodiments of the present disclosure will be described. The highlight mode of the present embodiment may include a first highlight mode (general), which highlights and displays a rear vehicle that is approaching from behind and can be seen; and a second highlight mode (blind spot), which performs further highlight and display of the rear vehicle that is approaching from behind and is determined as being about to enter the blind spot area.

According to an embodiment of the present disclosure, the alert target vehicle of the present vehicle V1, such as the rear vehicles V2 and V3, etc. shown in FIG. 2, is determined first. The control portion 102 of the vehicle alert device 100 (vehicle driver support system) determines whether or not the driver can see the alert target vehicle. Here, for example, it may be determined whether or not the driver can see the alert target vehicles V2 and V3 by using, for example, an image captured by a driver monitoring camera in the present vehicle V1. When the control portion 102 determines that the driver cannot see the alert target vehicles V2 and V3, the control portion 102 activates the BSI notification device 112 to notify the driver by using the existing blind spot monitoring system. In addition, when the control portion 102 determines that the driver can see the alert target vehicles V2 and V3, the control portion 102 activates the information display portion 110 to perform the highlighted display of the portion target vehicles V2 and V3 in this embodiment.

As shown in FIG. 2 and FIG. 3, taking the vehicle in the left rear direction as an example for description, when the driver sees a rear vehicle V2, if the position of the rear vehicle V2 in the left rear direction is within the driver's viewable range, such as the range θ22 as shown in FIG. 2, the driver may determine the rear vehicle V2 (and/or V3) from the rearview mirror M2. Therefore, in this embodiment, the vehicle alert device 100 may be used to enable the control portion 102 to determine whether or not the rear vehicle V2 is located in a position that the driver can determine based on the detection results (such as the above-mentioned distance and image) of the detection portion (radar 104, camera 106). If yes, the control portion 102 will take the rear vehicle V2 as the target vehicle, and output a control signal to the information display portion 110, so that the information display portion 110 adds a predetermined pattern 110a to the rear vehicle V2, such as the frame 110a shown in the drawing, to highlight the display of the rear vehicle V2. Here, the frame 110a is shown as a square, but the present disclosure is not limited thereto, and any suitable pattern may be used as the frame 110a.

In addition, in the continuous driving process of the rear vehicle V2, the frame 110a in the first highlighted display follows the movement of the rear vehicle V2, and the frame 110a continues to frame the rear vehicle V2 and moves accordingly. Thereby, the driver is able to continue to pay attention to the condition of the rear vehicle V2.

As shown in FIG. 5, the information display portion 110 has a frame 110a surrounding the rear vehicle V2, and the frame 110a may be displayed in an eye-catching color such as yellow, so as to be easily recognized by the driver. In this way, when the driver sees a vehicle like the rear vehicle V2 surrounded by the frame 110a in the rearview mirror M1, the driver may easily determine that the vehicle has approached the present vehicle V1, and there is a need for the driver to pay special attention. Compared with the existing technology, which only reflects the image of the left and right rear directions of the present vehicle V1 on the rearview mirrors M1 and M2, it is impossible to determine which rear vehicle needs to be noted with special attention, and the driver is very likely to be less attentive to the surrounding vehicles while changing lanes, and dangerous conditions might occur accordingly. However, according to the embodiments of the present disclosure, the approaching rear vehicle V2 (V3) may be added with the frame 110a in an eye-catching color through the information display portion 110, so that the driver is able to see the approaching rear vehicle V2 (V3) more easily, and pay more attention while driving.

In addition, by using the above method, when the control portion 102 obtains the information of the rear vehicle V2 (V3) based on the detection result of the detection device (such as the radar 104 and the camera 106, etc.), it is determined that the rear vehicle V2 (V3) is likely to enter the blind spot areas 200A and 200B of the present vehicle V based on the current driving state, the control portion 102 further controls the information display portion 110 to display the rear vehicle V2 in the second highlight mode.

According to an embodiment of the present disclosure, the second highlight mode provides a more obvious highlighted prompt for the driver on basis of the first highlight mode. For example, when the control portion 102 determines that the rear vehicle V2 is about to enter the blind spot area 200B of the present vehicle V1, the frame 110a in FIG. 5 is changed in display color from the state of simply indicating the rear vehicle V2. For example, the color of the frame 110a is changed from yellow in first highlight mode into red. In this way, the driver is able to see that the frame 110a displayed in the rearview mirror M1 has changed color, so as to make the driver notice that the rear vehicle V2 is about to enter the blind spot area 200B of the present vehicle V1, so it is possible to avoid operation of changing lanes and the like in such circumstances to avoid danger.

Furthermore, according to the embodiment of the present disclosure, in addition to changing the display color of the frame 110a in the second highlight mode, the frame 110a may also be changed to display in a flashing manner. Therefore, by displaying the frame 110a in a flashing manner, the driver is able to be more aware that the rear vehicle V2 is about to enter the blind spot area 200B of the present vehicle V1.

Similarly, the frame 110a highlighted in the second highlight display mode also follows the movement of the rear vehicle V2, the frame 110a continues to frame the vehicle rear V2 and moves accordingly, and the display color changes and flashes. As a result, the driver may continue to notice the situation of the rear vehicle V2 that is about to enter the blind spot area 200B.

Under this framework, compared with the existing technology, which only reflects the image of the left and right rear directions of the present vehicle V1 on the rearview mirrors M1 and M2, it is impossible to determine which rear vehicle is about to enter the blind spot areas 200A and 200B, and the driver is very likely to be less attentive to the surrounding vehicles while changing lanes, and dangerous conditions might occur accordingly. However, according to the embodiments of the present disclosure, the approaching rear vehicle V2 (V3) added with the frame 110a in an eye-catching color through the information display portion 110 may be further changed to display in a different color or flashing manner, so that the driver is able to determine more easily that the rear vehicle V2 (V3) is about to enter the blind spot areas 200A and 200B of the present vehicle V1, and pay more attention while driving.

Therefore, through the vehicle alert device of this embodiment, by using different highlight display modes of the rearview mirror, a more obvious display may be used especially for the rear vehicle that is about to enter the blind spot area, so that the driver is able to be more aware of various driving states of the rear vehicles, and then make correct judgments of driving to improve safety when driving vehicles.

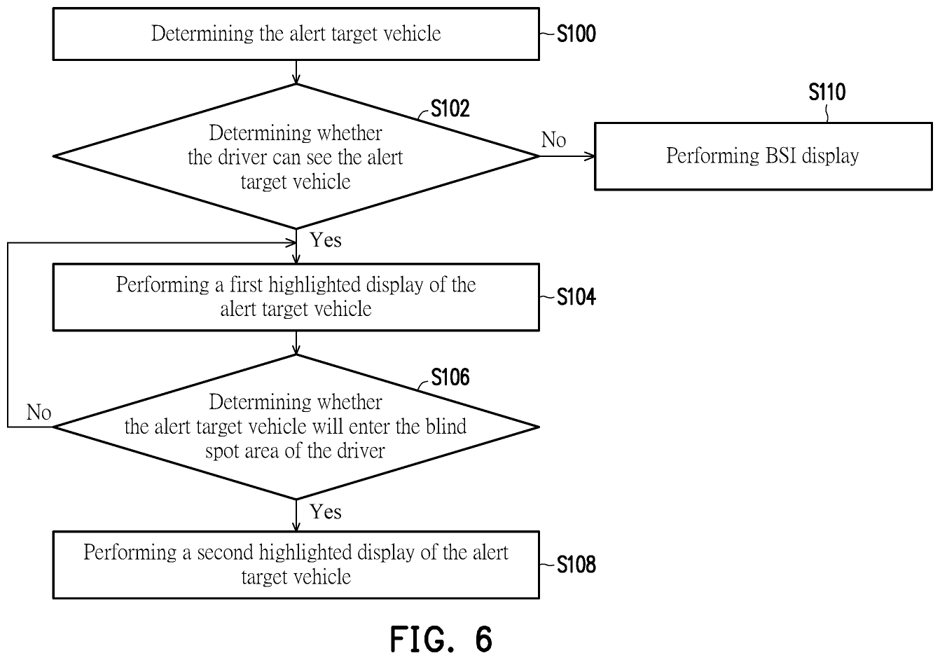

FIG. 6 is a schematic flowchart of a vehicle alert method according to an embodiment of the present disclosure. In step S100, for example, the control portion 102 shown in FIG. 1 executes the step of determining the alert target vehicle. The alert target vehicle is, for example, a part of the road participants. For example, vehicles travelling directly behind the present vehicle (e.g., in the same lane) or vehicles behind on both sides of the present vehicle (e.g., different lanes) may be regarded as the alert target vehicles.

In step S102, it is determined whether the driver can see the alert target vehicle, and this judgment may be performed by the control portion 102 in FIG. 1. The driver can see whether there are other vehicles approaching behind the present vehicle V1 through the interior rearview mirror inside the vehicle or a pair of rearview mirrors disposed on the exterior door. As described above, it is possible to determine whether or not the driver can see the alert target vehicles V2 and V3 by using, for example, an image captured by the driver monitoring camera in the present vehicle V1. For example, the driver's line of sight may be determined based on the image captured by the driver's monitoring camera, or by detecting whether there is a vehicle in a predetermined range (predetermine the range within which the vehicle is in the driver's line of sight) in the captured image as an alert target vehicle. Here, any method may be used for making judgment, and the present disclosure provides no limitation thereto.

When the determining result of step S102 is no, that is, when the control portion 102 determines that the driver cannot see the alert target vehicles V2 and V3, the control portion 102 will activate the BSI notification device 112 (S110) to notify the driver with the existing blind spot monitoring system. The operation mode of the BSI notification device 112 may be derived from the description of FIG. 3 and FIG. 4.

In addition, when the determining result of step S102 is yes, that is, when the control portion 102 determines that the driver can see the alert target vehicles V2 and V3, the control portion 102 will execute step S104 to activate the information display portion 110 to perform the first highlighted display of the alert target vehicles V2 and V3.

In step S104, a first highlighted display is performed on the alert target vehicles V2 and V3. Here, the control portion 102 controls the information display portion 110 to display a frame 110a, and the frame 110a dynamically surrounds the alert target vehicles V2 and V3. That is, the frame 110a shown in FIG. 5 moves along with the movement of the alert target vehicles V2 and V3. Here, the frame 110a may use a color that is obvious enough to attract the driver's attention, such as yellow or the like.

In step S106, it is determined whether the alert target vehicles V2 and V3 will enter the blind spot areas 200A and 200B of the present vehicle V1. In the above method of determining whether the alert target vehicles V2 and V3 are about to enter the blind spot area, the control portion 102 may determine whether the alert target vehicles V2 and V3 will enter the blind spot area of the present vehicle V1 based on the detection result of the detection portion. When it is determined that the alert target vehicles V2 and V3 are about to enter the blind spot areas 200A and 200B of the present vehicle V1, step S108 is executed.

In step S108, a second highlighted display is performed on the alert target vehicles V2 and V3 that are about to enter the blind spot area of the present vehicle V1. Here, the control portion 102 controls the information display portion 110 to change the color of the frame 110a displayed in the first highlighted display or make the frame 110a to flash, so as to notify the driver that the alert target vehicles V2 and V3 are about to enter the blind spot areas 200A and 200B of the present vehicle V1 in a highlight display method that attracts the driver's attention more.

In the above-mentioned embodiment, the rearview mirrors M1 and M2 are the examples where the transmissive display film (the information display portion 110) is pasted on the mirror surfaces, but the mirror surfaces of the entire rearview mirrors M1 and M2 may also directly adopt LCD display devices to replace conventional mirrors. In this variation example, the LCD display device may function as a rearview mirror and the information display portion simultaneously.

In the above embodiment, the present vehicle V1 is described as a car, which may include various types of vehicles, such as a general family car, a large truck, a bus, and so on. In this embodiment, a pair of rearview mirrors may be respectively arranged on the doors of the vehicle, such as the doors on the driver's side and the passenger's side. In addition, the notification device of this embodiment may also be disposed on a rearview mirror of a motorcycle.

Finally, it should be noted that: the above embodiments are only used to illustrate the technical solutions of the present disclosure, but not to limit them; although the present disclosure has been described in detail with reference to the foregoing embodiments, those of ordinary skill in the art should understand: modifications may still be made to the technical solutions described in the foregoing embodiments, or some or all of the technical features thereof are equivalently replaced; and these modifications or replacements do not make the essence of the corresponding technical solutions depart from the scope of the technical solutions of the embodiments of the present disclosure.

What is claimed is:

1. A vehicle alert device, comprising:
a detection portion, which detects an alert target vehicle among road participants around a present vehicle to obtain a detection result;
an information display portion, which is disposed on a pair of rearview mirrors of the present vehicle;
a control portion, which controls the information display portion to display a predetermined pattern on the information display portion when it is determined based on the detection result that the driver is able to see the alert target vehicle, so that the predetermined pattern is superimposed on the alert target vehicle displayed on the pair of rearview mirrors.

2. The vehicle alert device according to claim 1, wherein when the control portion determines based on the detection result that the alert target vehicle is about to enter a blind spot area of a driver of the present vehicle, the control portion performs a more obvious display than the predetermined pattern on the information display portion.

3. The vehicle alert device according to claim 2, wherein the more obvious display than the predetermined pattern comprises changing a shape or a color of the predetermined pattern, or displaying the predetermined pattern in a flashing manner.

4. The vehicle alert device according to claim 1, wherein the predetermined pattern is a frame.

5. The vehicle alert device according to claim 1, wherein the information display portion is a transmissive display film.

6. The vehicle alert device according to claim 1, wherein the detection portion acquires information of the alert target vehicle through at least one of a radar and a camera provided in the present vehicle.

7. A vehicle alert method, which is executed by a control portion of a present vehicle, wherein the present vehicle has a pair of rearview mirrors on which an information display portion is provided, the vehicle alert method comprising:
detecting an alert target vehicle among road participants around the present vehicle to obtain a detection result;
controlling the information display portion to display a predetermined pattern on the information display portion when it is determined based on the detection result that a driver is able to see the alert target vehicle, so that the predetermined pattern is superimposed on the alert target vehicle displayed on the pair of rearview mirrors.

8. The vehicle alert method according to claim 7, wherein when the control portion determines, based on the detection result, that the alert target vehicle is about to enter a blind spot area of a driver of the present vehicle, the control portion changes a shape or a color of the predetermined pattern, or display the predetermined pattern in a flashing manner.

9. The vehicle alert method according to claim 7, wherein the predetermined pattern is a frame.

10. A computer-readable recording medium, which stores a program, wherein a calculator executes the program to execute the vehicle alert method as claimed in claim 7.

11. A computer-readable recording medium, which stores a program, wherein a calculator executes the program to execute the vehicle alert method as claimed in claim 8.

12. A computer-readable recording medium, which stores a program, wherein a calculator executes the program to execute the vehicle alert method as claimed in claim 9.
